(19) United States
(12) Patent Application Publication
(10) Pub. No.: US 2020/0064699 A1
(43) Pub. Date: Feb. 27, 2020

(54) LIQUID CRYSTAL DISPLAY AND MANUFACTURING METHOD THEREOF

(71) Applicant: Samsung Display Co., Ltd., Yongin-Si (KR)

(72) Inventors: Hyo Suk PARK, Seoul (KR); Sae Ron PARK, Gimhae-si (KR); Ho-Yong SHIN, Suwon-si (KR); Jung Hyun AHN, Daejeon (KR); Sang Hun LEE, Suwon-si (KR)

(21) Appl. No.: 16/359,867

(22) Filed: Mar. 20, 2019

(30) Foreign Application Priority Data
Aug. 22, 2018 (KR) 10-2018-0098131

(51) Int. Cl. G02F 1/1362; G02F 1/1335; G02F 1/1337

(52) U.S. Cl. CPC G02F 1/136286; G02F 1/133516; G02F 1/136209; G02F 2201/123; G02F 2001/136222; G02F 2001/133519; G02F 2201/121; G02F 1/1337

(57) ABSTRACT

An exemplary embodiment of the present inventive concept provides a liquid crystal display, including an upper panel, a lower panel, and a liquid crystal layer disposed between the upper panel and the lower panel, wherein the lower panel may include a lower substrate, a plurality of data lines disposed on the lower substrate, and a plurality of color filters disposed between adjacent data lines of the plurality of data lines, the color filters may include a first color filter, a second color filter, and a third color filter, the first color filter may include a lower layer and an upper layer, and the first color filter may be disposed on the second color filter and the third color filter.

### CROSS-REFERENCE TO RELATED APPLICATION

This application claims priority to and the benefit of Korean Patent Application No. 10-2018-0098131, filed in the Korean Intellectual Property Office on Aug. 22, 2018, the entire contents of which are incorporated herein by reference.

### BACKGROUND

### (a) Technical Field

One or more aspects of embodiments of the present inventive concept are directed toward to a liquid crystal display and a method of manufacturing the same, and more particularly, to a liquid crystal display including a color filter and a method of manufacturing the same.

### (b) Description of the Related Art

A liquid crystal display (LCD), which is currently one of the most widely used flat panel displays, includes two sheets of display panels in which electrodes are formed and a liquid crystal layer interposed therebetween. The LCD applies voltages to electrodes to rearrange liquid crystal molecules of a liquid crystal layer, thereby controlling an amount of transmitted light.

Recently, as a resolution of the display device has increased and a size thereof has been enlarged, a division exposure method has been used in which a thin film pattern is formed by exposing a substrate of a large area through a plurality of shots using one mask in an exposure process.

The above information disclosed in this Background section is only for enhancement of understanding of the background of the invention and therefore it may contain information that does not form the prior art that is already known in this country to a person of ordinary skill in the art.

### SUMMARY

The present inventive concept has been made to provide a liquid crystal display and a manufacturing method thereof that may prevent a stitch stain from being visually recognized by reducing a deviation of a horn-shaped step at an overlap portion between color filters by forming a color filter having a large taper angle as a double layer by thin film coating, prevent occurrence of a gap in the overlap portion between the color filters to improve image quality, and improve uniformity of a cell gap and a capacitance (CO of a liquid crystal layer.

An exemplary embodiment of the present inventive concept provides a liquid crystal display, including an upper panel, a lower panel, and a liquid crystal layer disposed between the upper panel and the lower panel, wherein the lower panel may include a lower substrate, a plurality of data lines disposed on the lower substrate, and a plurality of color filters disposed between adjacent data lines of the plurality of data lines, the color filters may include a first color filter, a second color filter, and a third color filter, the first color filter may include a lower layer and an upper layer, and the first color filter may be disposed on the second color filter and the third color filter.

Each of the color filters may include a horn-shaped step disposed by partially overlapping an adjacent color filter at an upper portion of the data line, and a deviation between heights of different horn-shaped steps may be 0.3 μm or less, wherein each height of a horn-shaped step is measured from an upper surface of the data line to a maximum height of the color filter.

A taper angle of the first color filter may be 40 to 65 degrees.

A thickness of the plurality of color filters may be 3.5 μm or less.

The first color filter may be a red color filter that is configured to display a red color.

The lower panel may include a passivation layer disposed on the plurality of color filters, a pixel electrode disposed on the passivation layer, and a shielding electrode disposed on the same layer as the pixel electrode and disposed in a region corresponding to an upper portion of the data line; the upper panel may include an upper substrate, a light blocking member spaced from the upper substrate, and a common electrode disposed on the light blocking member; and a voltage equal to that of the common electrode may be applied to the shielding electrode.

The lower panel may include a passivation layer disposed on the plurality of color filters, a pixel electrode disposed on the passivation layer, a shielding electrode disposed on the same layer as the pixel electrode and disposed in a region corresponding to an upper portion of the data line, and a blocking member spaced from the pixel electrode and the shielding electrode, the upper panel may include an upper substrate and a common electrode disposed on the upper substrate, and a voltage equal to that of the common electrode may be applied to the shielding electrode.

Another embodiment of the present inventive concept provides a liquid crystal display, including an upper panel, a lower panel, and a liquid crystal layer disposed between the upper panel and the lower panel, wherein the upper panel may include an upper substrate, a light blocking member having an opening on the upper substrate, a plurality of color filters disposed in the opening of the light blocking member, an overcoat disposed on the color filter, and a common electrode disposed on the overcoat; the color filters may include a first color filter, a second color filter, and a third color filter; the first color filter may include a lower layer and an upper layer; and the first color filter may be disposed on the second color filter and the third color filter.

Each of the color filters may include a horn-shaped step disposed by partially overlapping an adjacent color filter at an upper portion of the data line, a deviation between heights of different horn-shaped steps may be 0.3 μm or less, wherein each height of a horn-shaped step is measured from an upper surface of the data line to a maximum height of the color filter.

A taper angle of the first color filter may be 40 to 65 degrees.

A thickness of the plurality of color filters may be 3.5 μm or less.

The first color filter may be a red color filter that displays a red color.

Another embodiment of the present inventive concept provides a manufacturing method of a liquid crystal display, including: forming a data line on a lower substrate to be spaced apart therefrom; forming a lower layer of a first color filter by primary thin film coating between adjacent data lines using a pattern mask; forming a second color filter between adjacent data lines by shifting the pattern mask; forming a third color filter between the adjacent data lines by shifting the pattern mask; and forming an upper layer of the first color filter by secondary thin film coating on the lower layer of the first color filter by shifting the pattern mask, wherein the lower layer may be formed so as to not overlap the second color filter, and opposite end portions of the upper layer may be respectively formed so as to overlap the second color filter and the third color filter at a predetermined portion in an upper region of the data line.

The color filter may include a horn-shaped step formed by partially overlapping the color filter adjacent thereto, a deviation between heights of different horn-shaped steps may be 0.3 μm or less wherein each height of a horn-shaped step is measured from an upper surface of the data line to a maximum height of the color filter.

The lower layer of the first color filter and the upper layer of the first color filter may have a taper angle ranging from 40 degrees to 65 degrees.

The lower layer may be formed to have a thickness of 2.5 μm or less, the upper layer may be formed to have a thickness of 1.5 μm or less, the second color filter and the third color filter may be formed to have a thickness of 3.5 μm or less, and the thickness of the lower layer may be equal to or smaller than the thickness of the data line.

Another embodiment of the present inventive concept provides a manufacturing method of a liquid crystal display, including: forming a light blocking member on an upper substrate; forming a lower layer of a first color filter by primary thin film coating between adjacent light blocking members using a pattern mask; forming a second color filter between the adjacent light blocking members by shifting the pattern mask; forming a third color filter between the adjacent light blocking members by shifting the pattern mask; and forming an upper layer of the first color filter by secondary thin film coating on the lower layer of the first color filter by shifting the pattern mask, wherein the lower layer may be formed so as to not overlap the second color filter, and opposite end portions of the upper layer may be respectively formed so as to overlap the second color filter and the third color filter at a predetermined portion in an upper region of the light blocking member.

The color filter may include a horn-shaped step formed by partially overlapping the color filter adjacent thereto, a deviation between heights of different horn-shaped steps may be 0.3 μm or less wherein each height of a horn-shaped step is measured from an upper surface of the data line to a maximum height of the color filter.

The lower layer of the first color filter and the upper layer of the first color filter may have a taper angle ranging from 40 degrees to 65 degrees.

The lower layer may be formed to have a thickness of 2.5 μm or less, the upper layer may be formed to have a thickness of 1.5 μm or less, the second color filter and the third color filter may be formed to have a thickness of 3.5 μm or less, and the thickness of the lower layer may be equal to or smaller than the thickness of the light blocking member.

According to the liquid crystal display and the manufacturing method thereof, it is possible to prevent a stitch stain from being visually recognized by reducing a deviation of a horn-shaped step at an overlap portion between color filters by forming a color filter having a large taper angle as a double layer by thin film coating. In addition, according to the liquid crystal display and the manufacturing method thereof, it is possible to prevent occurrence of a gap in the overlap portion between the color filters to improve image quality, and to improve uniformity of a cell gap and a capacitance (C_{LC}) of a liquid crystal layer.

### BRIEF DESCRIPTION OF THE DRAWINGS

FIG. 1 is a cross-sectional view of a liquid crystal display according to an exemplary embodiment.

FIGS. 2, 3, 4, 5, and 6 are cross-sectional views sequentially illustrating a method of manufacturing a lower panel of the liquid crystal display of FIG. 1.

FIG. 7 is a cross-sectional view of a liquid crystal display according to an exemplary embodiment.

FIG. 8 is a cross-sectional view of a liquid crystal display according to an exemplary embodiment.

### DETAILED DESCRIPTION OF THE EMBODIMENTS

The present inventive concept will be described more fully hereinafter with reference to the accompanying drawings, in which exemplary embodiments of the present inventive concept are shown. As those skilled in the art would realize, the described embodiments may be modified in various different ways, all without departing from the spirit or scope of the present disclosure.

Parts that are irrelevant to the description will be omitted to clearly describe the present disclosure, and like reference numerals designate like elements throughout the specification.

Further, in the drawings, the size and thickness of each element are arbitrarily illustrated for ease of description, and the present disclosure is not necessarily limited to those illustrated in the drawings. In the drawings, the thicknesses of layers, films, panels, regions, etc., are exaggerated for clarity. In the drawings, for ease of description, the thicknesses of some layers and areas are exaggerated.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion, and does not necessarily mean positioned on the upper side of the object portion based on a gravitational direction.

In addition, unless explicitly described to the contrary, the word “comprise” and variations such as “comprises” or “comprising” will be understood to imply the inclusion of stated elements but not the exclusion of any other elements.

Further, throughout the specification, the phrase “on a plane” means viewing a target portion from the top, and the phrase “on a cross-section” means viewing a cross-section formed by vertically cutting a target portion from the side.

Hereinafter, an exemplary embodiment of the present inventive concept will be described in detail with reference to the accompanying drawings.

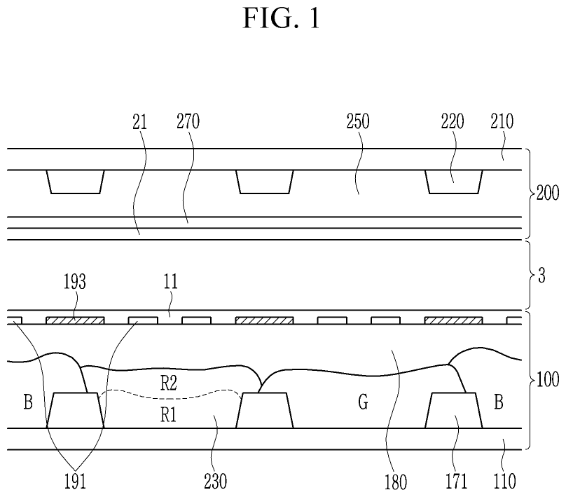

FIG. 1 is a cross-sectional view of a liquid crystal display according to an exemplary embodiment of the present inventive concept.

Referring to FIG. 1, a liquid crystal display according to an exemplary embodiment includes a lower panel 100 and an upper panel 200 facing each other, and a liquid crystal layer 3 interposed between the two panels.

First, the lower panel 100 will be described.

The lower panel 100 includes a lower substrate 110, a data line 171, a gate line (not shown) crossing the data line 171, a thin film transistor (not shown) connected to the data line 171 and the gate line, a color filter 230, a passivation layer 180, a pixel electrode 191, a shielding electrode 193, and a lower alignment layer 11.

Although not shown, a gate line may extend in one direction on the lower substrate 110 made of transparent glass or plastic. A gate insulating layer may be formed on the gate line including the gate electrode, and a semiconductor layer may be formed thereon. The data line 171 for transmitting a data signal may be formed on the semiconductor layer. The data line 171 may include a source electrode or a drain electrode, and the source electrode or the drain electrode may be formed of an island-like conductor.

The gate electrode, the source electrode, and the drain electrode may form a thin film transistor (TFT) together with the semiconductor layer. A structure of the thin film transistor described above is only one exemplary embodiment, and the structure of the thin film transistor may be of various other forms.

In the exemplary embodiment of FIG. 1, the data line 171 may extend in one direction crossing the gate line on the lower substrate 110, and adjacent data lines 171 are spaced apart from each other in a cross-sectional view of FIG. 1.

A plurality of color filters 230 are formed between adjacent data lines 171. The plurality of color filters 230 may include a red color filter R, a green color filter G, and a blue color filter B. Each color filter 230 is formed by extending a color filter of the same color in a direction in which the data line 171 extends. However, the formation of the color filter is not limited thereto. Respective ends of each of the plurality of color filters 230 are formed so that predetermined portions thereof overlap each other on the data lines 171.

The red color filter R may include a double layer of a first red color filter R1 and a second red color filter R2. In this case, the first red color filter R1, which is a lower layer of the double layer, and the second red color filter R2, which is an upper layer of the double layer, may include the same photo-resist (PR) displaying a red color. Therefore, although the first red color filter R1 and the second red color filter R2 are hardly distinguishable by the naked eye, since they are separately formed, they are separately referred to.

Hereinafter, a sectional profile of the color filter will be described.

The first red color filter R1 is formed between the adjacent data lines 171 (in a pixel region), and the green color filter G is formed between data lines 171 adjacent to a right side thereof. Respective ends of the green color filter G may be in contact with an upper surface of the data line 171. The second red color filter R2 is formed on one end portion of the green color filter G, and the blue color filter B is formed on the other end portion thereof. The green color filter G does not overlap the first red color filter R1, and different end portions of the green color filter G may overlap the second red color filter R2 and the blue color filter B, respectively.

The blue color filter B is formed between the first red color filter R1 and the data line 171 where the green color filter G is not formed. One end portion of the blue color filter B contacts an upper surface of the data line 171, and the second red color filter R2 is formed on that end portion of the blue color filter B. The other end portion of the blue color filter B is formed on the data line 171 and the green color filter G. The blue color filter B does not overlap the first red color filter R1, and different end portions of the blue color filter B may overlap the second red color filter R2 and the green color filter G, respectively.

The second red color filter R2 is formed on the first red color filter R1, and opposite end portions of the second red color filter R2 may overlap the blue color filter B and the green color filter G, respectively. According to the sectional profile of the color filters 230 described above, since the red color filter R is formed as the double layer, the green color filter G, the blue color filter B, and the red color filter R are sequentially formed. That is, the red color filter R may be formed on the green color filter G and the blue color filter B. The above formation order may be understood by looking at the positions of the portions of each color filter 230 that overlap with each other.

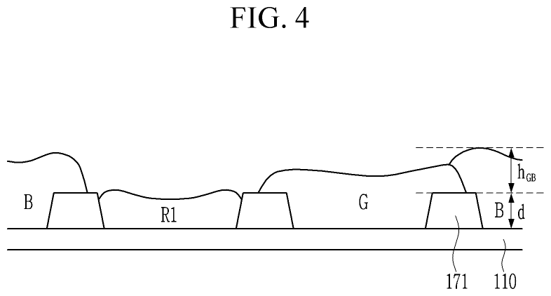

Generally, the overlapped portion in which the color filters 230 are overlapped may have a horn-shaped step toward an upper surface thereof, compared with other portions in which the color filters 230 are not overlapped. Hereinafter, the step is referred to as a horn-shaped step, and will be described in detail with reference to FIG. 4 to FIG. 6.

The color filter 230 may uniquely display one of primary colors, and the primary colors may be three primary colors such as red, green, and blue as described above. Alternatively, the primary colors may be yellow, cyan, magenta, etc. Although not shown, the color filter 230 may further include a color filter 230 that displays a mixed color of the primary colors or a white color in addition to the primary colors.

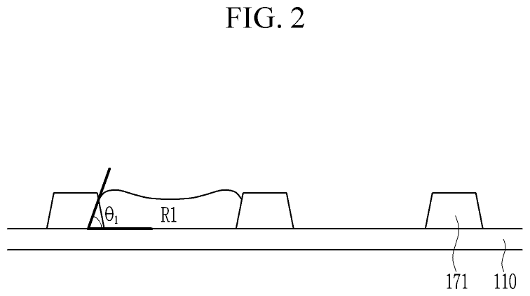

The color filter 230 may include a photo-resist (PR) that uniquely displays one of the above-described examples. Since, during formation, the photo-resist (PR) has fluidity as an organic material, the color filter 230 may be formed to be inclined with respect to a surface of the lower substrate 110. Hereinafter, the inclined angle is referred to as a taper angle, and will be described in detail with reference to FIG. 2 to FIG. 6.

The passivation layer 180 for protecting the color filter 230 is formed on the color filter 230. The passivation layer 180 may serve to flatten the surface above the the color filter 230 after the color filter 230 is formed on the lower substrate 110.

The pixel electrode 191 is formed on the passivation layer 180. The pixel electrode 191 may be physically and electrically connected to the drain electrode through a contact hole (not shown) formed in the passivation layer 180 to be able to receive a voltage from the drain electrode. Although not shown, a flat surface of the pixel electrode 191 may be formed to have various patterns. For example, the pixel electrode 191 may include a center electrode and a fine branch extending from the center electrode.

In this case, as shown in the cross-sectional view of FIG. 1, the pixel electrodes 191 may be spaced apart at predetermined intervals.

In addition, the shielding electrode 193 is formed in the same layer as the pixel electrode 191. The shielding electrode 193 may be formed in a region corresponding to the upper portion of the data line 171. The shielding electrode 193 may not be separated for each pixel region, but may be connected to all the adjacent pixels to form one electrode.

A voltage equal to that of a common electrode 270 formed on the upper substrate 210, which will be described later, is applied to the shielding electrode 193. Since the same voltage is applied to the shielding electrode 193 and the common electrode 270, an electric field is not generated between the shielding electrode 193 and the common electrode 270, and the liquid crystal layer 3 disposed therebetween is not aligned. Accordingly, a liquid crystal between the shielding electrode 193 and the common electrode 270 is in a black state. When the liquid crystal is in a black state, the liquid crystal itself may function just like a light blocking member 220. Accordingly, when the shielding electrode 193 is formed along the data line 171 as shown in FIG. 1, the light blocking member 220 may not be formed on the data line 171.

The lower alignment layer 11 is coated on the pixel electrode 191 and the shielding electrode 193, and the lower alignment layer 11 may be a horizontal alignment layer and may be rubbed in a predetermined direction. However, in the display device according to the exemplary embodiment, the lower alignment layer 11 may include a photo-reactive material and be photo-aligned.

Hereinafter, the upper panel 200 will be described. The upper panel 200 may include the upper substrate 210, the light blocking member 220, an overcoat 250, the common electrode 270, and an upper alignment layer 21.

The light blocking member 220 for preventing light leakage is formed on the upper substrate 210 made of transparent glass or plastic. The light blocking member 220 may be formed to correspond to a region of the thin film transistor disposed on the lower substrate 110. In addition, the light blocking member 220 may be formed on the lower substrate 110, and this exemplary embodiment will be described later.

The overcoat 250 is formed on the light blocking member 220. The overcoat 250 may serve to flatten the upper substrate 210 on which the light blocking member 220 is formed. The overcoat 250 may be omitted.

The common electrode 270 is formed on the overcoat 250. The common electrode 270 is for operating a pixel together with the pixel electrode 191 formed on the lower substrate, and thus may be provided with an opening (not shown) corresponding to the pixel electrode 191. The upper alignment layer 21 is formed on the common electrode 270. The upper alignment layer 21 may be a vertical alignment layer.

Hereinafter, with reference to FIGS. 2 to 6 and FIG. 1, a method of manufacturing the lower panel 100 of the liquid crystal display according to the exemplary embodiment will be described.

FIGS. 2 to 6 are cross-sectional views sequentially illustrating processes of the method of manufacturing the lower panel of the liquid crystal display of FIG. 1.

Referring to FIG. 2, the data line 171, a gate line (not shown) crossing the data line 171, and a thin film transistor (not shown) connected to the data line 171 and the gate line may be formed on the lower substrate 110 as an insulating substrate. The gate line may extend in one direction. The data line 171 may be formed to extend in one direction crossing the gate line, and adjacent data lines may be formed to be spaced apart from each other in a cross-sectional view.

Next, the first red color filter R1 may be formed by coating a thin film between the adjacent data lines 171 using a pattern mask (primary thin film coating). In this case, the first red color filter R1 may be formed to have a thickness of about 2 μm, and may be inclined with respect to the lower substrate 110. The inclined angle is referred to as a taper angle. A first taper angle θ₁, which is a taper angle of the first red color filter R1, may be formed to have a range of about 45 degrees to 60 degrees. For example, the slope of an end of first red color filter R1 that meets the data line 171, if that end were extended to meet the lower substrate 110, would form a first taper angle θ₁ having a range of about 45 degrees to 60 degrees with respect to the lower substrate 110.

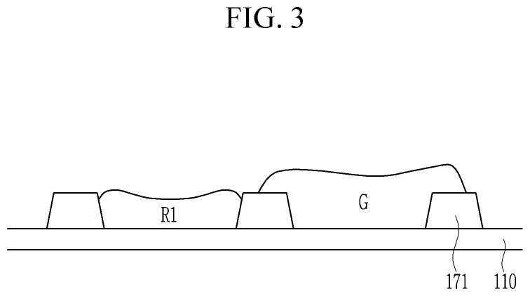

Referring to FIG. 3, the green color filter G is formed by using the pattern mask. By shifting the pattern mask, the green color filter G may be formed between adjacent data lines 171 in which the first red color filter R1 is not formed. In this case, a thickness of the green color filter G may be thicker than that of the first red color filter R1. The thickness of the green filter G may be from about 2 μm to 3.5 μm.

In this case, the green color filter G may not overlap the first red color filter R1. The taper angle of the green color filter G may have a range similar to and/or the same as that of the first red color filter R1 even if the green color filter G is formed to be thicker than the first red color filter R1.

Referring to FIG. 4, the blue color filter B is formed by using the pattern mask. By shifting the pattern mask, the blue color filter B may be formed between adjacent data lines 171 in which the first red color filter R1 and the green color filter G are not formed. In this case, a thickness of the blue color filter B may be thicker than that of the first red color filter R1. The thickness of the blue filter B may be about 2 μm to 3.5 μm.

In this case, the blue color filter B may not overlap the first red color filter R1. One end portion of the blue color filter B may overlap the green filter G to form an overlapped portion, and the overlapped portion may form a GB horn-shaped step h_{GB}. Hereinafter,

the horn-shaped step is defined as a height from the upper surface of the data line 171 (i.e., the highest height of the data line 171) to the highest height of each color filter 230. The highest height of the color filter 230 may be positioned at a portion at which adjacent color filters 230 overlap at opposite end portions, the opposite end portions distinguished from a portion formed relatively flat at a center portion of the color filter 230.

The GB horn-shaped step h_{GB} is a height from the upper surface of the data line 171 to the highest height of the blue color filter B. The data line 171 has a constant thickness d from the lower substrate 110.

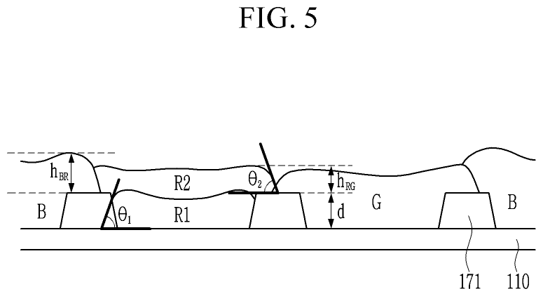

Referring to FIG. 5, the second red color filter R2 is formed by using the pattern mask. The second red color filter R2 may be formed by shifting the pattern mask again between the adjacent data lines 171 at which the first red color filter R1 is formed. The second red color filter R2 may be formed by coating a thin film on the first red color filter R1 (secondary thin film coating).

The second red color filter R2 may be formed to have a thickness of about 1.5 μm. The second red color filter R2 may be formed to be inclined by a second taper angle θ₂ with respect to the lower substrate 110. The second taper angle θ₂ may be about 45 degrees to 60 degrees. For example, the slope of an end of the second red color filter R2 that meets the green color filter G, if that end were extended to meet either the top of the data line 171 or the lower substrate 110, would form a second taper angle θ₂ of about 45 degrees to 60 degrees with respect to the top of the data line 171 or the lower substrate 110.

In this case, unlike the first red color filter R1, one end portion of the second red color filter R2 may form an overlap portion with the green color filter G, and the overlap portion may form a RG horn-shaped step h_{RG}. The RG horn-shaped step h_{RG} is a height from the upper surface of the data line 171 to the highest height of the second red color filter R2. The data line 171 has a constant thickness d from the lower substrate 110.

In addition, unlike the first red color filter R1, the second red color filter R2 may overlap the blue color filter B, and the overlap portion may form a BR horn-shaped step h_{BR}. The BR horn-shaped step h_{BR} is a height from the upper surface of the data line 171 to the highest height of the blue color filter B.

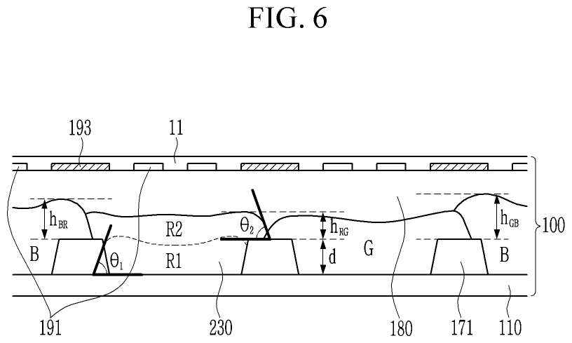

Referring to FIG. 6, the passivation layer 180 is formed on the color filter 230, and the pixel electrode 191 is formed on the passivation layer 180. The shielding electrode 193 is formed in a region corresponding to the upper portion of the data line 171 in the same layer as the pixel electrode 191.

Referring to FIG. 1 again, the upper substrate 210 is prepared, then the light blocking member 220, the overcoat 250, the common electrode 270, and the upper alignment layer 21 are sequentially formed on the upper substrate 210 to form the upper panel 200. The upper panel 200 and the lower panel 100 according to the exemplary embodiment of FIG. 6 face each other with a predetermined gap therebetween, then the liquid crystal layer 3 may be formed by injecting liquid crystal therebetween. A spacer (not shown) may be disposed between the upper display panel 200 and the lower display panel 100.

Recently, as a substrate has become larger, a divided exposure method has been used in which a plurality of shots are exposed with a single mask to form a pattern. Herein, performing the exposure once with a mask is called a shot. When the shot is moved, pattern misalignment may occur. In an exemplary embodiment of the present inventive concept, the widths of the overlap portions of the color filters 230 of different colors and the horn-shaped steps of the overlap portions may vary.

On the other hand, as the display device is developed to have high resolution (QUHD), the number of pixels may increase and a size of one pixel may decrease. Therefore, influence of the overlap portion and the horn-shaped step of the color filter is increased at opposite end portions of the color filter in one pixel region. As a result, a degree of exposure between adjacent shots varies, thus a stitch failure may occur, which causes the left and right colors to appear differently.

Generally, when the color filters 230 have a predetermined thickness, a taper angle of the red color filter R is the largest, so that the RG horn-shaped step h_{RG} may be higher than the GB horn-shaped step h_{GB} and the BR horn-shaped step h_{BR}.

When the red color filters R1 and R2 are formed to have a thickness of 3 μm or more, the taper angles θ₁ and θ₂ may be more than 60 degrees. Particularly, in a case of a photo-resist (PR) for displaying a red color included in the red color filter R, the taper angles θ₁ and θ₂ rapidly increase, thus a reverse tapered structure having an angle of 90 degrees or more may be formed.

Thus, according to the exemplary embodiment of the present inventive concept, by forming the first red color filter R1 and the second red color filter R2 of the red color filter R to have a thickness of 3 μm or less through two thin film coating processes, it is possible to prevent the taper angle from increasing. Accordingly, by reducing the RG horn-shaped step G h_{RG} at the overlap portion between the red color filter R and the green color filter, it is possible to reduce the deviation between the GB cone step h_{GB} and the BR cone step hBR.

As described in the example of FIG. 3, the first red color filter R1 is formed to have a thickness of 3 μm or less, and the first taper angle 01 may be formed to be about 45 degrees to about 60 degrees. The first red color filter R1 is formed so as to not overlap the green color filter G. As described in FIG. 6, since the green color filter G is not formed above the red color filter R having a large taper angle, but the second red color filter R2 is formed on the green color filter G having a small taper angle, the RG horn-shaped step h_{RG} may be reduced.

Specifically, the thickness of the first red color filter R1 formed by the first thin film coating process may be about 2 μm, and the thickness of the second red color filter R2 formed by the second thin film coating process may be about 1.5 μm. Thus, the deviation (i.e., the difference in height) between the RG horn-shaped step h_{RG} and the other horn-shaped steps h_{GB} and h_{BR} is 0.3 μm, thereby preventing the stitch defect from being visually recognized.

The second red color filter R2 is formed on the first red color filter R1 and the green color filter G so that one end portion of the second red color filter R2 partially overlaps the green color filter G. In this case, the second taper angle θ₂ of the second red color filter R2 may be about 45 degrees to 60 degrees.

Generally, the thinner the thickness of the color filter 230, the higher the transparency thereof, and the thicker the thickness of the color filter 230, the higher the color reproducibility thereof. In the exemplary embodiment of the present inventive concept, in order to realize a high color of each color filter 230, the thickness thereof should be more than a predetermined thickness, but when the color filter 230 is formed to be greater than the predetermined thickness, the taper angle increases, so that the horn-shaped step may be increased. Therefore, the thickness of the color filter 230 may be formed in a range of about 2 μm to 3.5 μm in order to realize the high color while maintaining the taper angle at about 45 to 60 degrees. For example, the color filter 230 may be formed to have a thickness of 2.4 μm to 3.4 μm.

In addition, even if a flow characteristic for filling the gap of the green filter G is not good, a second taper angle (θ₂) of the second red color filter R, which is in contact with the green filter G, is not large, thus it is possible to prevent a gap from being generated between the red color filter R and the green color filter G. For example, it is possible to solve a problem of occurrence of a gap caused by the green filter G not filling a reverse tapered space, wherein the taper angle of the red color filter R is as large as 90 degrees or more.

In addition, the RG horn-shaped step h_{RG} is reduced, and thus the deviation between the horn-shaped steps of the color filters 230 is reduced, so that a cell gap of the liquid crystal display and the capacitance C_{LC} of the liquid crystal layer 3 may be made constant at the overlap portion of the color filter 230. As a result, it is possible to improve the liquid crystal alignment defects and display quality defects.

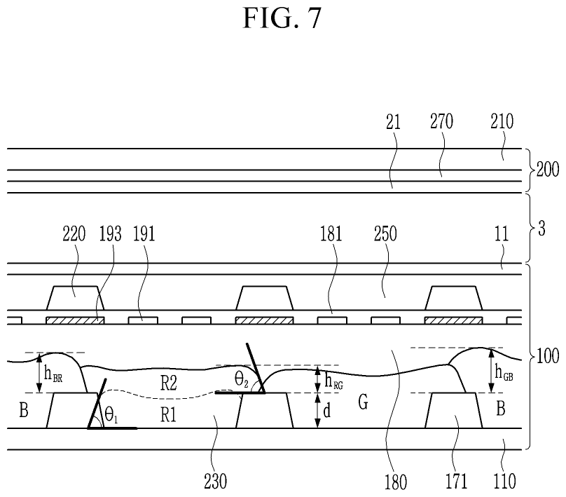

Hereinafter, a liquid crystal display device according to an exemplary embodiment will be described with reference to FIG. 7. FIG. 7 is a cross-sectional view of a liquid crystal display according to an exemplary embodiment.

In the exemplary embodiment of FIG. 7, the light blocking member 220 is distinguished from the exemplary embodiment of FIG. 1 in that the light blocking member 220 is formed on the lower substrate 110 rather than the upper substrate 210.

Features that are different from the exemplary embodiment of FIG. 1 will be described, and features that are not described follow the above-described exemplary embodiment.

Referring to FIG. 7, the display device according to the present exemplary embodiment includes the lower panel 100 and the upper panel 200 facing each other, and the liquid crystal layer 3 interposed between the two panels.

First, the lower panel 100 will be described.

In the exemplary embodiment of FIG. 7, a first passivation layer 181 for protecting the pixel electrode 191 and the shielding electrode 193 is formed on the pixel electrode 191 and the shielding electrode 193. The light blocking member 220 is formed to be spaced apart on the first passivation layer 181. The light blocking member 220 may be formed in a region corresponding to the upper portion of the data line 171 and the shielding electrode 193.

The overcoat 250 is formed on the light blocking member 220. The overcoat 250 may serve to flatten the lower substrate 110 on which the light blocking member 220 is formed. The lower alignment layer 11 is formed on the overcoat 250.

Hereinafter, the upper panel 200 will be described.

The upper panel 200 may include the upper substrate 210, the common electrode 270, and the upper alignment layer 21. The common electrode 270 and the upper alignment layer 21 are sequentially formed on the upper substrate 210.

In the exemplary embodiment of FIG. 7, by forming the red color filter R as a double layer of the first red color filter R1 and the second red color filter R2 through two thin film coating processes, it is possible to prevent the taper angle from increasing. Thus, the deviation between the RG horn-shaped step h_{RG} and the other horn-shaped steps h_{GB} and h_{BR} is made to be 0.3 μm, thereby preventing the stitch defect from being visually recognized.

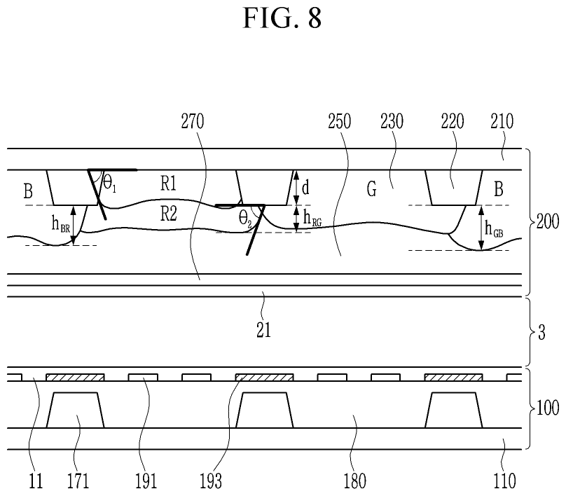

Hereinafter, a liquid crystal display device according to an exemplary embodiment will be described with reference to FIG. 8. FIG. 8 is a cross-sectional view of a liquid crystal display according to an exemplary embodiment.

The exemplary embodiment of FIG. 8 is distinguished from the exemplary embodiment of FIG. 1 in that the color filter 230 is disposed on the upper substrate 210, not on the lower substrate 110, and the color filter 230 is disposed between adjacent light blocking members 220 rather than the adjacent data lines 171.

Features that are different from the exemplary embodiment of FIG. 1 will be described, and features that are not described follow the above-described exemplary embodiment.

Referring to FIG. 8, the display device according to the present exemplary embodiment includes the lower panel 100 and the upper panel 200 facing each other, and the liquid crystal layer 3 interposed between the two panels.

First, the lower panel 100 will be described.

The lower panel 100 may include the lower substrate 110, the data line 171, the gate line (not shown) crossing the data line 171, the thin film transistor (not shown) connected to the data line 171 and the gate line, the passivation layer 180, the pixel electrode 191, the shielding electrode 193, and the lower alignment layer 11.

The data line 171 may extend in one direction on the lower substrate 110 to cross the gate line, and adjacent data lines 171 are spaced apart from each other in the sectional view of FIG. 8.

The passivation layer 180 is formed on the data line 171. The passivation layer 180 serves to flatten the lower substrate 110 on which the data lines 171 are formed. The pixel electrode 191 and the shielding electrode 193 are formed on the passivation layer 180, and the lower alignment film 11 is formed on these electrodes.

Hereinafter, the upper panel 200 will be described.

The upper panel 200 may include the upper substrate 210, the light blocking member 220, the color filter 230, the overcoat 250, the common electrode 270, and the upper alignment layer 21.

The light blocking member 220 having an opening (not shown) is formed on the upper substrate 210 so as to be spaced apart therefrom. The light blocking member 220 may be formed in a region corresponding to the upper portion of the data line 171 and the shielding electrode 193.

The plurality of color filters 230 are formed in the opening of the light blocking member 220. In this case, the cross-sectional profile of the color filter 230 corresponds to that of the exemplary embodiment described above.

The overcoat 250 is formed on the color filter 230. The overcoat 250 may serve to flatten the upper substrate 210 on which the color filter 230 is formed. The common electrode 270 and the upper alignment layer 21 are sequentially formed on the overcoat 250.

In this case, the light blocking member 220 has a predetermined thickness d from the upper substrate 210.

Even in the exemplary embodiment of FIG. 8, by forming the red color filter R as a double layer of the first red color filter R1 and the second red color filter R2 through two thin film coating processes, it is possible to prevent the taper angle from increasing. Thus, the deviation between the RG horn-shaped step h_{RG} and the other horn-shaped steps h_{GB} and h_{BR} is made to be 0.3 μm, thereby preventing the stitch defect from being visually recognized.

While the present inventive concept has been described in connection with what is presently considered to be practical exemplary embodiments, it is to be understood that the present inventive concept is not limited to the disclosed embodiments, but, on the contrary, is intended to cover various modifications and equivalent arrangements included within the spirit and scope of the appended claims.

### DESCRIPTION OF SYMBOLS

| | |
|---|---|
| 100: lower panel | 200: upper panel |
| 11, 21: alignment layer | 3: liquid crystal layer |
| 110: lower substrate | 210: upper substrate |
| 171: data line | 180, 181: passivation layer |
| 191: pixel electrode | 193: shielding electrode |
| 220: light blocking member | 230: color filter |
| 250: overcoat | 270: common electrode |

What is claimed is:

1. A liquid crystal display, comprising an upper panel, a lower panel, and a liquid crystal layer disposed between the upper panel and the lower panel,
wherein the lower panel includes a lower substrate, a plurality of data lines disposed on the lower substrate, and a plurality of color filters disposed between adjacent data lines of the plurality of data lines,
the color filters include a first color filter, a second color filter, and a third color filter,
the first color filter includes a lower layer and an upper layer, and
the first color filter is disposed on the second color filter and the third color filter.

2. The liquid crystal display of claim 1, wherein
each of the color filters include a horn-shaped step disposed by partially overlapping an adjacent color filter at an upper portion of the data line, and
a deviation between heights of different horn-shaped steps is 0.3 μm or less, wherein each height of a horn-shaped step is measured from an upper surface of the data line to a maximum height of the color filter.

3. The liquid crystal display of claim 1, wherein
a taper angle of the first color filter is 40 to 65 degrees.

4. The liquid crystal display of claim 1, wherein
a thickness of the plurality of color filters is 3.5 μm or less.

5. The liquid crystal display of claim 1, wherein
the first color filter is a red color filter that is configured to display a red color.

6. The liquid crystal display of claim 1, wherein
the lower panel includes a passivation layer disposed on the plurality of color filters, a pixel electrode disposed on the passivation layer, and a shielding electrode disposed on the same layer as the pixel electrode and disposed in a region corresponding to an upper portion of the data line,
the upper panel includes an upper substrate, a light blocking member spaced from the upper substrate, and a common electrode disposed on the light blocking member, and
a voltage equal to that of the common electrode is applied to the shielding electrode.

7. The liquid crystal display of claim 1, wherein
the lower panel includes a passivation layer disposed on the plurality of color filters, a pixel electrode disposed on the passivation layer, a shielding electrode disposed on the same layer as the pixel electrode and disposed in a region corresponding to an upper portion of the data line, and a blocking member spaced from the pixel electrode and the shielding electrode,
the upper panel includes an upper substrate and a common electrode disposed on the upper substrate, and
a voltage equal to that of the common electrode is applied to the shielding electrode.

8. A liquid crystal display, comprising an upper panel, a lower panel, and a liquid crystal layer disposed between the upper panel and the lower panel,
wherein the upper panel includes an upper substrate, a light blocking member having an opening on the upper substrate, a plurality of color filters disposed in the opening of the light blocking member, an overcoat disposed on the color filter, and a common electrode disposed on the overcoat,
the color filters include a first color filter, a second color filter, and a third color filter,
the first color filter includes a lower layer and an upper layer, and
the first color filter is disposed on the second color filter and the third color filter.

9. The liquid crystal display of claim 8, wherein
each of the color filters include a horn-shaped step disposed by partially overlapping an adjacent color filter adjacent at an upper portion of the data line, and
a deviation between heights of different horn-shaped steps is 0.3 μm or less, wherein each height of a horn-shaped step is measured from an upper surface of the data line to a maximum height of the color filter.

10. The liquid crystal display of claim 8, wherein
a taper angle of the first color filter is 40 to 65 degrees.

11. The liquid crystal display of claim 8, wherein
a thickness of the plurality of color filters is 3.5 μm or less.

12. The liquid crystal display of claim 8, wherein
the first color filter is a red color filter that displays a red color.

13. A manufacturing method of a liquid crystal display, comprising:
forming a data line on a lower substrate to be spaced apart therefrom;
forming a lower layer of a first color filter by primary thin film coating between adjacent data lines using a pattern mask;
forming a second color filter between adjacent data lines by shifting the pattern mask;
forming a third color filter between the adjacent data lines by shifting the pattern mask; and
forming an upper layer of the first color filter by secondary thin film coating on the lower layer of the first color filter by shifting the pattern mask,
wherein the lower layer is formed so as to not overlap the second color filter, and
opposite end portions of the upper layer are respectively formed so as to overlap the second color filter and the third color filter at a predetermined portion in an upper region of the data line.

14. The manufacturing method of the liquid crystal display of claim 13, wherein
the color filter includes a horn-shaped step formed by partially overlapping the color filter adjacent thereto, and
a deviation between heights of different horn-shaped steps is 0.3 μm or less, wherein each height of a horn-shaped step is measured from an upper surface of the data line to a maximum height of the color filter.

15. The manufacturing method of the liquid crystal display of claim 13, wherein
the lower layer of the first color filter and the upper layer of the first color filter have a taper angle ranging from 40 degrees to 65 degrees.

16. The manufacturing method of the liquid crystal display of claim 13, wherein
the lower layer is formed to have a thickness of 2.5 μm or less,
the upper layer is formed to have a thickness of 1.5 μm or less,
the second color filter and the third color filter are formed to have a thickness of 3.5 μm or less, and
the thickness of the lower layer is equal to or smaller than the thickness of the data line.

17. A manufacturing method of a liquid crystal display, comprising:
forming a light blocking member on an upper substrate;
forming a lower layer of a first color filter by primary thin film coating between adjacent light blocking members using a pattern mask;
forming a second color filter between the adjacent light blocking members by shifting the pattern mask;
forming a third color filter between the adjacent light blocking members by shifting the pattern mask; and
forming an upper layer of the first color filter by secondary thin film coating on the lower layer of the first color filter by shifting the pattern mask,
wherein the lower layer is formed so as to not overlap the second color filter, and
opposite end portions of the upper layer are respectively formed so as to overlap the second color filter and the third color filter at a predetermined portion in an upper region of the light blocking member.

18. The manufacturing method of the liquid crystal display of claim 17, wherein
the color filter includes a horn-shaped step formed by partially overlapping the color filter adjacent thereto, and
a deviation between heights of different horn-shaped steps is 0.3 μm or less, wherein each height of a horn-shaped step is measured from an upper surface of the data line to a maximum height of the color filter.

19. The manufacturing method of the liquid crystal display of claim 17, wherein
the lower layer of the first color filter and the upper layer of the first color filter have a taper angle ranging from 40 degrees to 65 degrees.

20. The manufacturing method of the liquid crystal display of claim 17, wherein
the lower layer is formed to have a thickness of 2.5 μm or less,
the upper layer is formed to have a thickness of 1.5 μm or less,
the second color filter and the third color filter are formed to have a thickness of 3.5 μm or less, and
the thickness of the lower layer is equal to or smaller than the thickness of the light blocking member.
